(19) United States
(12) Patent Application Publication
(10) Pub. No.: US 2021/0245392 A1
(43) Pub. Date: Aug. 12, 2021

(54) Ethanol-Based Extraction of Soluble Wood Components

(71) Applicant: RF Kettle Company, LLC, Fletcher, NC (US)

(72) Inventors: Keith A. Mort, Fletcher, NC (US); Chadwick E. Slagle, Black Mountain, NC (US)

(73) Assignee: RF Kettle Company, LLC, Fletcher, NC (US)

(21) Appl. No.: 17/173,277

(22) Filed: Feb. 11, 2021

Related U.S. Application Data
(60) Provisional application No. 62/972,992, filed on Feb. 11, 2020.

(51) Int. Cl. B27K 5/00

(52) U.S. Cl. CPC B27K 5/001; B27K 2240/10; B27K 5/0055; B27K 5/0085

(57) ABSTRACT

A method (10) for ethanol-based extraction of soluble wood components. Wood is prepared (12), and chipped (18) to provide wood chips. The wood chips and a liquid are mixed (20) in a container to provide a mixture. After waiting (22) for a specified time, RF energy is applied (26) to the mixture while controlling (28) at least one an RF power level, a temperature of the mixture, a time of application of the RF energy, or a speed of a pump which is circulating the liquid in the mixture. The mixture is then cooled (30), the liquid and the components are removed (32) from the container, and are filtered (36) to provide a filtered extract. The wood may be heated (14) such as by charring and/or toasting before being chipped. Oxygen may be added (34) to the liquid and the components removed from the container before being filtered.

### CROSS-REFERENCE TO RELATED APPLICATION

This application claims priority to U.S. Provisional Patent Application Ser. No. 62/972,992 filed on Feb. 11, 2020, entitled “Method And Apparatus For Ethanol-Based Wood Extraction,” the disclosure and drawing of which are hereby incorporated herein in their entirety by reference.

### BACKGROUND

Conventional cask-ageing of distilled spirits requires specialized wooden casks, storage under specified conditions, months to years of ageing, and loses a noticeable amount of ethanol (ethyl-alcohol) via evaporation through the cask.

### SUMMARY

A method for ethanol-based extraction of soluble wood components is disclosed. The method includes preparing wood, chipping the wood to provide wood chips, mixing the wood chips and a liquid in a container to provide a mixture, waiting for a specified time, applying RF energy to the mixture while controlling at least one an RF power level, a temperature of the mixture, a time of application of the RF energy, or a speed of a pump which is circulating the liquid in the mixture, cooling the mixture, removing the liquid and components extracted from the wood, and filtering the liquid and the soluble wood components extracted from the wood to provide a filtered extract.

An apparatus for ethanol-based extraction of soluble wood components is also disclosed. The apparatus includes a tank selected to withstand effects of wood chips, ethanol, and application of RF energy to the wood chips and ethanol, an RF energy generator, an RF transmission feed connected between the RF energy generator and a top of the tank, and a control panel connected to the RF energy generator to control at least one of an RF power or an application time of RF power.

### BRIEF DESCRIPTION OF THE DRAWING

For a fuller understanding of the nature of the present invention, reference should be made to the following detailed description, taken in conjunction with the accompanying drawings in which:

FIGS. 1A and 1B are a flowchart of a method for ethanol-based extraction of soluble wood components.

FIG. 2 illustrates a system for ethanol-based extraction of soluble wood components.

Like reference numerals refer to like parts throughout the several Figures of the drawing.

### DETAILED DESCRIPTION

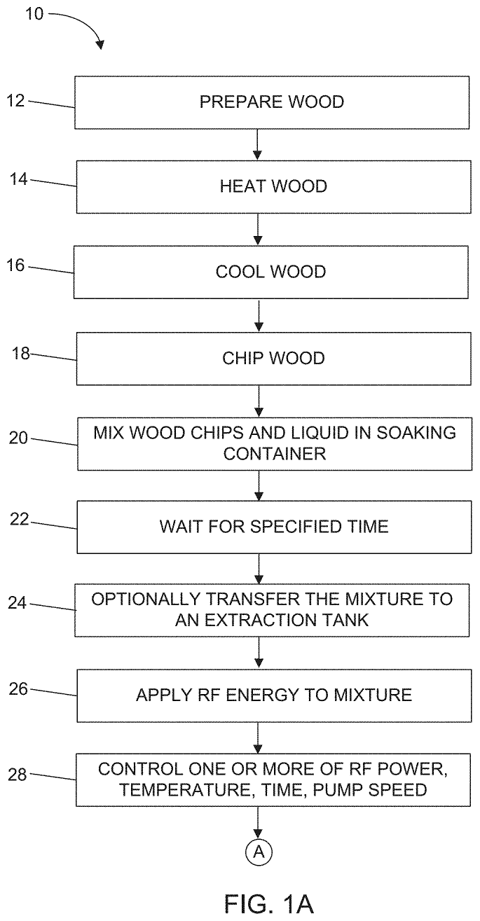

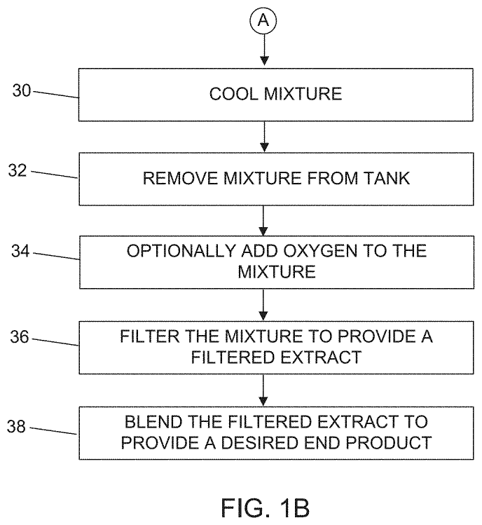

FIGS. 1A and 1B are a flowchart of a method 10 for ethanol-based extraction of soluble wood components. This method provides accelerated ageing to produce an ethanolic product in less time, and with less alcohol evaporation, than conventional cask storage. The method also provides for accelerated ageing and production of a distilled ethanolic product. In accordance with an exemplary embodiment of the method 10, for ethanol-based wood extraction, wood is prepared 12 by sanding, cleaving, planing, and/or cutting the wood into pieces approximately one-inch square and in lengths of anywhere between three inches and twenty-four inches, inclusive. These wood pieces are then processed to make strips approximately three to twenty-four inch long strips, which may vary in size from ¼ inch by ¼ inch to 1 inch by 1 inch, inclusive. The wood may be white oak, maple, mesquite, birch, hickory, cherry, another wood species, and/or a combination of two of more thereof.

The wood is then preferably, but not necessarily, heated 14. The heating may be with an open flame or heating element to char the wood surface, and/or the wood may be toasted by heating it in an oven for a period of 3 to 5 hours at a temperature ranging between 350 to 450 degrees Fahrenheit, inclusive. Charring and/or toasting the wood breaks down the structure of the wood and makes soluble wood components more readily available during the subsequent soaking and RF energy application steps below.

The wood, if heated in step 14, is then cooled 16, preferably to ambient temperature.

The wood is then chipped 18, preferably into randomly-sized wood pieces approximately the size of conventional mulch. Pieces thicker than about ¼ inch are preferably removed as it will take longer for those thick pieces to absorb the desired liquid, below.

The wood chips are then mixed 20 with a desired liquid. A volume of the wood chips is added to, submerged in, or soaked in, a liquid, in a soaking container. The wood chips may be raw wood chips, toasted wood chips, charred wood chips, or a combination of two or three thereof. The liquid is preferably an ethanol base that is between 45% alcohol by volume to 75% alcohol by volume, inclusive, with the balance preferably being water. The soaking container is preferably a closed container made of either stainless steel or solvent resistant plastic. In an embodiment, the weight of the wood chips is between about 2.0 and 23.0 ounces per 1 gallon of liquid.

The mixture is then allowed to soak or mature by waiting 22 for a specified time, preferably a period ranging between approximately 24 and 168 hours, inclusive. Preferably, the specified time is sufficient to allow any floating wood chips to sink. This soaking allows the ethanol and water to be absorbed into the cells and capillaries of the wood. The ethanol and water act as solvents for the soluble wood components in the cells and capillaries. The fluid may be circulated, if desired, such as by a pump and hoses pulling liquids from the bottom of the container to the stop of the container.

It is not necessary to heat the mixture during this time. If, however, the mixture is heated, it is neither greatly heated nor boiled.

The wood and ethanol base mixture may be transferred 24 from the soaking container into an extraction tank. The extraction tank is preferably stainless-steel. If the soaking container is stainless steel then it may also be used as the extraction tank, in which case the mixture need not be transferred.

RF energy is then applied 26 to the mixture in the extraction tank to heat the mixture.

Preferably, at least one of the following is controlled 28: the RF (microwave) energy power input, the temperature of the mixture, the time that RF energy is to be applied, and the pump speed of a pump which is circulating the fluid in the extraction tank. It is not necessary to stir or circulate the wood chips in the mixture. The RF energy is delivered and/or distributed into the “load,” i.e., the mixture of ethanol and wood chips in the extraction tank. The RF energy is preferably at a frequency of approximately 915 Megahertz. Other frequency ranges may also be utilized to provide the desired heating.

The RF energy may be applied for a time period of between 15 minutes to 360 minutes. During this time the mixture reaches a temperature of around 150 degrees Fahrenheit. The heating caused by exposure of the mixture to the RF energy enhances the solvent characteristics of the ethanol and water, and allows for and/or causes expansion of the cells and capillaries of the wood. This results in, and/or aids in, the ethanol and the water exiting the cells and capillaries and, as they exit, they bring with them the soluble wood components, such as tannins, lignin, cellulose, hemicellulose, acids, esters, wood sugars, and/or phenolic compounds from the wood chips. Thus, in addition to wood chips, ethanol, and water, the mixture in the extraction tank now also contains a wood extract, i.e., one or more of the soluble wood components mentioned above.

After the desired time is complete, the mixture is cooled down 30 to between 100 and 110 degrees Fahrenheit.

The mixture is then removed 32 from the extraction tank and pumped into a wood, oak, or plastic container. Removal may be accomplished by, for example, gravity through a low point drain, or by a pump.

Depending on the desired end product, oxygen is optionally added 34 to the mixture by way of an oxygen delivery system, such as bubbling oxygen through the mixture.

The mixture is then filtered 36 to remove wood solids to provide a filtered extract containing ethanol, water, and the soluble wood components.

The filtered extract may then be blended 38 with another ethanolic product and/or with water in order to dilute or change the flavor, aroma, and/or other characteristic of the filtered extract to provide the desired end product.

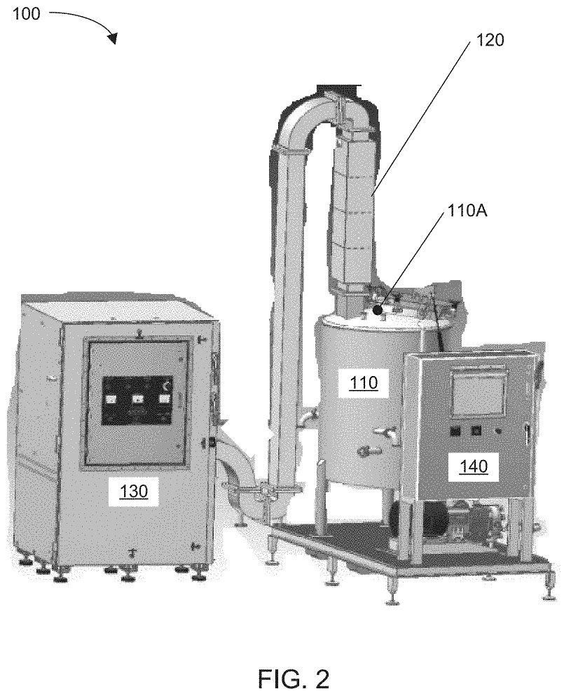

FIG. 2 illustrates a system 100 for ethanol-based extraction of soluble wood components. The system 100 includes an extraction tank 110 (which may also be referred to herein as an extraction vessel or an extraction container). The extraction tank 110 is preferably stainless steel. As mentioned above, soaking of the wood chips may be performed in the extraction tank 110 or in a separate soaking container. The extraction tank 110 tank has a waveguide or RF transmission feed 120, coaxial connection, or antenna, which is typically but not exclusively connecting an RF transmitter or generator 130 to the top 110A of the extraction tank. This connection between the transmitter or generator 130 to the extraction tank 110 allows the RF or microwave energy to be delivered and or distributed into the “load” (the mixture of ethanol, water, and wood chips) contained inside the extraction tank 110.

A control panel 140 controls the RF or microwave energy power input, the temperature that is to be reached and maintained, the time for soaking, the time for application of the RF or microwave energy, the pump speed, and other parameters, and may also display the current state of measured parameters, such as the temperature.

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations may be well known in the art, and because they do not facilitate a better understanding of the present disclosure, a discussion of such elements and operations is not provided herein. The present disclosure is deemed to inherently include all such elements, variations, and modifications to the described aspects that would be known to those of ordinary skill in the art, particularly in view of reading the present disclosure. Any headings used herein are for organizational purposes only and are not meant to be used to limit the scope of the description or the claims.

The terminology used herein is for the purpose of describing particular example embodiments only and is not intended to be limiting. As used herein, the singular forms “a”, “an”, and “the” may be intended to include the plural forms as well, unless the context clearly indicates otherwise.

The terms “comprises,” “comprising,” “includes,” “including,” “has,” “having,” and variations in form thereof are inclusive or variations in form thereof are intended to be inclusive in a manner similar to the term “comprises” as that term is interpreted when employed as a transitional word in a claim, and therefore specify the presence of stated features, integers, steps, operations, elements, and/or components, but do not preclude the presence or addition of one or more other features, integers, steps, operations, elements, components, and/or groups thereof unless explicitly stated otherwise or the context clearly requires otherwise.

The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments are contemplated, described herein, and set forth in the claims.

The term “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner.

For convenience of discussion herein, when there is more than one of a component, that component may be referred to herein either collectively or singularly by the singular reference numeral unless expressly stated otherwise or the context clearly indicates otherwise. For example, components N (plural) or component N (singular) may be used unless a specific component is intended. Also, the singular forms “a,” “an,” and “the” are intended to include the plural forms as well, unless expressly stated otherwise or the context indicates otherwise.

The terms “includes,” “has,” “having,” or “exhibits,” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items.

As used herein, phrases such as “between X and Y” and “between about X and Y” should be interpreted to include X and Y unless expressly stated otherwise or the context clearly indicates otherwise.

Terms such as “about”, “approximately”, “around”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While terms such as vertical, horizontal, upper, lower, bottom, top, and the like may be used herein, it is to be understood that these terms are used for ease in referencing the drawing and, unless otherwise indicated or required by context, does not denote a required orientation.

The different advantages and benefits disclosed and/or provided by the implementation(s) disclosed herein may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments preferably or optionally include certain features, elements and/or steps, while some other embodiments optionally do not include those certain features, elements and/or steps. Thus, such conditional language indicates, in general, that those features, elements and/or steps are used in a permissive sense rather than a mandatory sense, and may not be required for every implementation or embodiment.

The subject matter described herein is provided by way of illustration only and should not be construed as limiting the nature and scope of the claims herein. While different embodiments have been provided above, it is not possible to describe every conceivable combination of components or methodologies for implementing the disclosed subject matter, and one of ordinary skill in the art may recognize that further combinations and permutations that are possible. Furthermore, the nature and scope of the claims is not necessarily limited to implementations that solve any or all disadvantages which may have been noted in any part of this disclosure. Various modifications and changes may be made to the subject matter described herein without departing from the spirit and scope of, the exemplary embodiments and applications illustrated and described herein.

Although the subject matter presented herein has been described in language specific to components used therein, it is to be understood that the scope of the claims is not necessarily limited to the specific components or characteristics thereof described herein; rather, the specific components and characteristics thereof are disclosed as example forms of implementing the disclosed subject matter. Accordingly, the disclosed subject matter is intended to embrace all alterations, modifications, and variations, that fall within the scope and spirit of any claims that may be written therefor.

The foregoing Detailed Description is intended only to convey to a person having ordinary skill in the art the fundamental aspects of the disclosed subject matter and is not intended to limit, and should not be construed as limiting, the scope of the claims herein. Further, in the foregoing Detailed Description, various features may be grouped together in a single embodiment for the purpose of streamlining the disclosure. This method of disclosure is not to be interpreted as reflecting an intention that the claimed embodiments require more features than are expressly recited in each claim. Rather, as the following claims reflect, patentable subject matter may lie in less than all features of a single disclosed embodiment. Thus any claims following below are hereby incorporated into the Detailed Description, with each claim standing on its own as a separate embodiment.

1. A method for ethanol-based extraction of soluble wood components, the method comprising:
preparing wood;
chipping the wood to provide wood chips;
mixing the wood chips and a liquid in a first container to provide a mixture;
waiting for a specified time;
applying RF energy to the mixture while controlling at least one an RF power level, a temperature of the mixture, a time of application of the RF energy, or a speed of a pump which is circulating the liquid in the mixture;
cooling the mixture; and
filtering the mixture to remove wood solids liquid and provide a filtered extract.

2. The method of claim 1, and after cooling the mixture, and before filtering the mixture, further comprising:
adding oxygen to the mixture.

3. The method of claim 1, wherein the liquid is ethanol.

4. The method of claim 1, and further comprising blending the filtered extract with another liquid.

5. The method of claim 1, and further comprising blending the filtered extract with an ethanolic product.

6. The method of claim 1, and further comprising blending the filtered extract with water.

7. The method of claim 1, wherein preparing wood comprises at least one of sanding, cleaving, planing, or cutting the wood into pieces approximately one-inch square.

8. The method of claim 1, wherein preparing wood comprises at least one of sanding, cleaving, planing, or cutting the wood into pieces which are between three inches and twenty-four inches, inclusive.

9. The method of claim 1, wherein the wood comprises at least one of: white oak, maple, mesquite, birch, hickory, pine, pecan, apple, red oak, or cherry.

10. The method of claim 1, and after preparing the wood, and before chipping the wood, further comprising:
heating the wood; and
cooling the wood.

11. The method of claim 10, wherein heating the wood comprises at least one of:
charring a surface of the wood by an open flame or a heating element, or toasting the wood by heating it in an oven for a period of 3 to 5 hours at a temperature between 350 to 450 degrees Fahrenheit, inclusive.

12. The method of claim 1, wherein chipping the wood converts the wood chips into randomly-sized wood pieces approximately the size of conventional mulch.

13. The method of claim 1, wherein the specified time is between approximately 24 and 168 hours, inclusive.

14. The method of claim 1, and while waiting for the specified time, further comprising circulating the liquid in the first container.

15. The method of claim 1, and after waiting for the specified time, transferring the mixture to a second container.

16. The method of claim 1, and after waiting for the specified time, transferring the mixture to a second container, wherein the second container is stainless steel.

17. An apparatus for ethanol-based extraction of soluble wood components, the apparatus comprising:
a tank selected to withstand effects of wood chips, ethanol, water, and application of RF energy to the tank;
an RF energy generator;
an RF transmission feed connected between the RF energy generator and a top of the tank; and
a control panel connected to the RF energy generator to control at least one of an RF power or an application time of RF power.

18. The apparatus of claim 17, wherein the RF energy is microwave energy.

19. The apparatus of claim 17, wherein the RF transmission feed is a waveguide.

20. The apparatus of claim 17, wherein the tank is stainless steel.
